(19) United States
(12) Patent Application Publication
(10) Pub. No.: US 2013/0311611 A1
(43) Pub. Date: Nov. 21, 2013

(54) METHOD AND DEVICE FOR EXECUTING A DEVICE MANAGEMENT COMMAND BASED ON AN EXECUTION TIME

(71) Applicants: Jonghoon Shim, Seoul (KR); Hyoungjun Park, Seoul (KR)

(72) Inventors: Jonghoon Shim, Seoul (KR); Hyoungjun Park, Seoul (KR)

(73) Assignee: LG ELECTRONICS INC., Seoul (KR)

(21) Appl. No.: 13/983,323

(22) PCT Filed: Dec. 12, 2012
(86) PCT No.: PCT/KR2012/010790

§ 371 Date: Aug. 2, 2013

(30) Foreign Application Priority Data
Dec. 12, 2011 (KR) 1020110133010

(51) Int. Cl. H04L 29/08

(52) U.S. Cl. CPC H04L 67/10
USPC 709/217

(57) ABSTRACT

An operation method of a device management server for relaying a device management command is disclosed in the present disclosure, and the method may include receiving a management command from a first device, determining an execution method of the management command as a relay scheme or message exchange scheme according to a kind of the management command, and transmitting a management command for a second device according to the execution method.

### TECHNICAL FIELD

The present disclosure relates to a method and device for executing a device management command, and more particularly, to a method and device for executing a device management command based on an execution time of the device management command.

### BACKGROUND ART

Device management refers to a technology for providing a function such as user custom-made setting, remote management, update, and the like to an electronic device. The device management technology may be used for the purpose of fabrication process for a product, initial setting after purchase, batch update for errors and modification items, remote management for a product, and the like.

Technologies defined by Open Mobile Alliance (hereinafter, OMA) are used as standard technologies for application programs and services in the area of mobile communication. The OMA deals with mobile web, web browsing, DRM solution, IP multimedia, device management, mobile broadcast, mobile related document standardization, and the like to promote interoperability of mobile data services.

In particular, the standardization of technologies for device management in the OMA allows processes such as firmware update, software download, new service, error correction, and the like to be carried out in a wireless manner.

### DISCLOSURE OF INVENTION

### Technical Problem

However, when technologies based on device management defined by the OMA to perform the processes in a wireless manner are applied to general home appliances, there may occur a phenomenon that time required to perform a management command in the real-time property is increased.

### Solution to Problem

An objective of the present disclosure is to provide a method of allowing a management server that has received a management command for an electronic device from a mobile station to execute the management command in a different manner based on a kind of management command.

According to the standard for device management of the OMA, it is defined to execute a management command by an operating entity of the management server without providing a function of receiving a management command for an electronic device from the user. An operation method of a management server disclosed herein proposes a function of transferring a management command entered by the user from a mobile station to the electronic device.

Furthermore, according to the present disclosure, there is proposed a method of reducing a time required by the transfer of a management command and reception of an execution result for a kind of management command needed to be executed within a specific period of time among management commands.

For this purpose, according to the present disclosure, there is proposed a method of determining whether or not the management command is a command having the real-time property, and executing the management command in a different execution method based on the determination result.

As an embodiment, there is disclosed an operation method of a device management server for relaying a device management command. The operation method of a device management server may include receiving a management command from a first device, determining an execution method of the management command as a relay scheme or message exchange scheme according to a kind of the management command, and transmitting a management command for a second device according to the execution method.

The foregoing embodiment and other embodiments may include any one of the following characteristics.

Said determining an execution method of the management command may include judging whether the management command requires real-time execution, and determining the execution method according to the judgement result. Furthermore, the execution method may be determined as the relay scheme when it is judged that the management command requires real-time execution in the step of determining the execution method. Furthermore, said transmitting the management command according to the relay scheme may include establishing a connection oriented session with the second device, transmitting the management command through the session, and receiving an execution result of the management command from the second device through the session. Furthermore, the connection oriented session may be maintained without being released until receiving an execution result of the management command from the second device.

Furthermore, the operation method of a device management server may further include transmitting an execution result of the management command received from the second device to the first device.

Furthermore, said judging whether the management command requires real-time execution may be judging whether the management command should be executed within a predetermined period of time after receiving the management command. Furthermore, a monitoring command for monitoring an operation status of the second device may be judged to require real-time execution in the step of judging whether to require the real-time execution. Furthermore, a control command for changing the power, operating mode or job reservation status of the second device may be judged to require real-time execution in the step of judging whether to require the real-time execution. Furthermore, a diagnosis command for examining whether there is an error in the operation of the second device may be judged to require real-time execution in the step of judging whether to require the real-time execution.

Furthermore, said transmitting the management command according to the relay scheme may be transmitting the management command according to a scheme of transferring the management command conforming to the device management standard of the Open Mobile Alliance (OMA).

As another embodiment, there is disclosed a device management server for relaying a device management command. The device management server may include a communication unit configured to perform communication with a first device and a second device, and a controller configured to control the communication unit, wherein the controller controls to receive a management command from the first device, determine an execution method of the management command as a relay scheme or message exchange scheme according to a kind of the management command, and transmit a management command for a second device according to the execution method.

The foregoing another embodiment and other embodiments may include any one of the following characteristics.

The controller may judge whether the management command requires real-time execution, and determine the execution method of the management command according to the judgement result. Furthermore, the controller may determine the execution method as the relay scheme when it is judged that the management command requires real-time execution. Furthermore, the relay scheme may transmit the management command and receive an execution result of the management command through a connection oriented session established with the second device, and the connection oriented session may be maintained without being released until receiving an execution result of the management command from the second device. Furthermore, when judging whether the management command requires real-time execution, a monitoring command for monitoring an operation status of the second device, a control command for changing the power, operating mode or job reservation status of the second device, and a diagnosis command for examining whether there is an error in the operation of the second device may be judged to require real-time execution.

As a still another embodiment, there is disclosed an electronic device. The electronic device may include a home appliance module, a memory configured to store a monitoring program for monitoring the home appliance module, a communication unit configured to perform communication with a device management server, and a controller configured to manage the monitoring program using a message exchange scheme or relay scheme with the device management server, wherein the controller receives an update command for the monitoring program from the device management server using the message exchange scheme, and updates the monitoring program according to the update command, and transmits the updated result of the monitoring program to the device management server using the message exchange scheme, and receives a monitoring command from the device management server using the relay scheme, and executes the monitoring program based on the monitoring command to acquire the status information of the home appliance module, and transmits the status information to the device management server using the relay scheme.

According to an operation method of a device management server in accordance with the embodiments disclosed herein, a management command having the real-time property may be transferred to an electronic device through a connection oriented session, and maintains the session until the execution of the management command is completed, thereby receiving the execution result of the command without any delay for establishing an additional session.

According to an operation method of a device management server in accordance with the embodiments disclosed herein, an execution method conforming to the conventional device management standard of the OMA may be used for a management command in the non-real-time property.

According to an operation method of a device management server in accordance with the embodiments disclosed herein, a command having the real-time property such as a monitoring command may be transferred to an electronic device to be carried out using a relay scheme, and a command having the non-real-time property such as updating an application program may be transferred to an electronic device to be carried out based on the conventional device management standard of the OMA.

According to the embodiments disclosed herein, it may be possible to reduce time delay occurred when a management command in the real-time property is carried out.

### BRIEF DESCRIPTION OF DRAWINGS

FIG. 1 illustrates a device management system to which a technology disclosed herein is applicable;

FIG. 2 illustrates an example of an electronic device to which a technology disclosed herein is applicable;

FIG. 3 illustrates processes in which an electronic device and a management server according to the OMA device management standard exchange messages for device management;

FIG. 4 illustrates a method in which a mobile station transfers a management command to an electronic device through a management server and receives an execution result;

FIG. 5 illustrates the process of executing a device management command through an OMA device management (DM) message between an electronic device and a management server;

FIG. 6 illustrates the process of executing a device management command through a relay server between an electronic device and a management server;

FIG. 7 is a flow chart for explaining the process of updating an application program of the electronic device according to a request of the mobile station as an example of the device management method disclosed herein; and

FIG. 8 is a flow chart for explaining the process of performing the monitoring of the electronic device according to a request of the mobile station as an example of the device management method disclosed herein.

### MODE FOR THE INVENTION

It should be noted that technological terms used herein are merely used to describe a specific embodiment, but not to limit the present invention. Also, unless particularly defined otherwise, technological terms used herein should be construed as a meaning that is generally understood by those having ordinary skill in the art to which the invention pertains, and should not be construed too broadly or too narrowly. Furthermore, if technological terms used herein are wrong terms unable to correctly express the spirit of the invention, then they should be replaced by technological terms that are properly understood by those skilled in the art. In addition, general terms used in this invention should be construed based on the definition of dictionary, or the context, and should not be construed too broadly or too narrowly.

Incidentally, unless clearly used otherwise, expressions in the singular number include a plural meaning. In this application, the terms “comprising” and “including” should not be construed to necessarily include all of the elements or steps disclosed herein, and should be construed not to include some of the elements or steps thereof, or should be construed to further include additional elements or steps.

Furthermore, the terms used herein including an ordinal number such as first, second, etc. can be used to describe various elements, but the elements should not be limited by those terms. The terms are used merely to distinguish an element from the other element. For example, a first element may be named to a second element, and similarly, a second element may be named to a first element.

In case where an element is “connected” or “linked” to the other element, it may be directly connected or linked to the other element, but another element may be existed therebetween. On the contrary, in case where an element is “directly connected” or “directly linked” to another element, it should be understood that any other element is not existed therebetween.

Hereinafter, preferred embodiments of the present invention will be described in detail with reference to the accompanying drawings, and the same or similar elements are designated with the same numeral references regardless of the numerals in the drawings and their redundant description will be omitted. In describing the present invention, moreover, the detailed description will be omitted when a specific description for publicly known technologies to which the invention pertains is judged to obscure the gist of the present invention. Also, it should be noted that the accompanying drawings are merely illustrated to easily explain the spirit of the invention, and therefore, they should not be construed to limit the spirit of the invention by the accompanying drawings. The spirit of the invention should be construed as being extended even to all changes, equivalents, and substitutes other than the accompanying drawings.

Hereinafter, the term “terminal” is used, but the terminal may be also called a user equipment (UE), a mobile equipment (ME), and a mobile station (MS), a mobile subscriber station (MSS), a user terminal (UT), a subscriber station (SS), a mobile subscriber station (MSS), a wireless device, a handheld device, and an access terminal (AT).

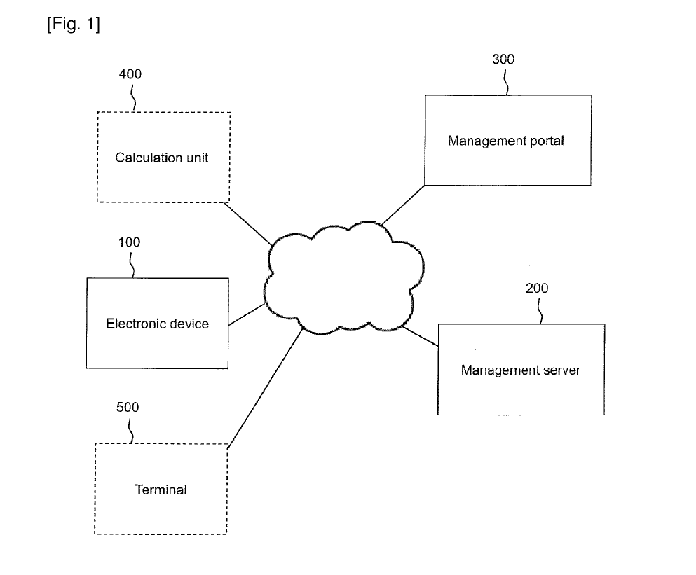

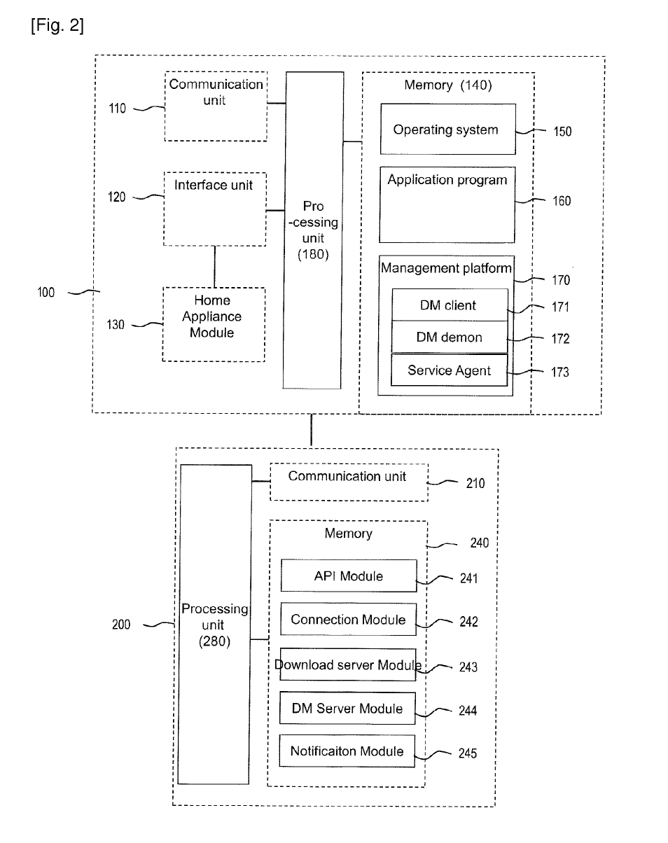

Hereinafter, referring to FIGS. 1 and 2, entities within a device management system according to the embodiments disclosed herein will be described. FIG. 1 illustrates a device management system to which a technology disclosed herein is applicable. FIG. 2 illustrates an example of an electronic device to which a technology disclosed herein is applicable.

Referring to FIG. 1, the device management system may include an electronic device 100 and a management server 200.

The electronic device 100 is an object of device management, which corresponds to various home appliance devices, communication devices, and the like. The electronic device 100 can perform a management command requested from the management server 200. The electronic device 100 may be a home appliance device. The electronic device may include a home appliance module 130 corresponding to hardware with a home appliance function, and may be an intelligent home appliance device having application programs for using the home appliance module 130 in various ways.

The management server 200 is a device for implementing a management service for the electronic device 100. In particular, the management server 200 may include modules for requesting the execution of a management command to the electronic device 100, and receiving the execution result of the management command to provide it to the user. The detailed configuration of the electronic device 100 and the management server 200 will be described later in detail with reference to FIG. 2.

The device management system may further include a management portal 300. The management portal 300 is a server for providing a user's subscription and support services for the electronic device 100. The management portal 300 may be configured to perform a function of managing the user of the electronic device 100, and a function of performing product authentication of the electronic device 100. The management portal 300 may be a device or service system operated by a manufacturer of the electronic device 100 or a seller of the electronic device 100.

On the other hand, the device management system may further include a computing device 400. The computing device 400 is a device used to access services provided by the management portal 300. The computing device 400 may be a device provided with a network function and a user interface such as a personal computer or the like, for instance. The computing device 400 may be used to manage information on the electronic device 100 or information on the user.

On the other hand, the device management system may further include a mobile station 500. The mobile station 500 is a device used to access management services for the electronic device 100 provided by the management server 200. The mobile station 500 may use the management services through Application Programming Interface (API) provided from the management server 200. The mobile station described in the present disclosure is any type of electronic equipment capable of accessing the management server to use management services for the electronic device including a device management (DM) client, and should be construed as a meaning including a portable phone, a cellular phone, a smart phone, a personal digital assistants (PDAs), portable multimedia player (PMP), a tablet device, a computer, a multimedia player or the like, for instance.

Referring to FIG. 2, the electronic device 100 may include a communication unit 110, an interface unit 120, a memory 140, and a processing unit 180.

The communication unit 110 is a communication module for transmitting and receiving control messages for executing a management command, data required for the management command execution, a result of the management command execution, and the like. The communication unit 110 may include a wireless communication module 111 or wired communication module 112 for performing communication with the management server 200. In particular, the wireless communication module 111 may be a module for performing communication with a device located within a short distance, which supports near field communication technologies such as Bluetooth, Radio Frequency IDentification (RFID), Infrared Data Association (IrDA), Ultra WideBand (UWB), ZigBee, Wireless LAN (protocols such as Bluetooth, 802.11n, etc.) and the like.

The interface unit 120 performs the role of connecting to the home appliance module 130 within the electronic device 100. The interface unit 120 is operated to transmit and receive control signals and status information according to a management command for the home appliance module 130. The interface unit 120 may be implemented in the form of a library needed to execute a management command between the home appliance module 130 and the device management (DM) client 171 or device management (DM) daemon 172.

The home appliance module 130 connected through the interface unit 120 may be hardware for executing a washing function, a cooking function, a cleaning function, or storage function. Specifically, the processing unit 180 can control the home appliance module 130 connected to through the interface unit 120 according to a control method contained in the application program 160 stored in the memory 140.

A program for operating the processing unit 180 may be stored in the memory 140, and input and output data may be temporarily stored therein.

Furthermore, various software components may be stored in the memory 140. Specifically, an operating system (OS) 150, application programs 160, and a management platform 170 may be stored in the memory 140. Furthermore, software components including a module operated together with the communication unit 110 and a module operated together with the interface unit 120 may be stored in the memory 140.

The operating system 150 (for example, LINUX, UNIX, OS X, WINDOWS, Chrome, Symbian, WinCE, Windows Mobile, iOS, Android, Bada, VxWorks, pSOS or other embedded operating systems) may include various software components and/or drivers for controlling system tasks such as memory management, power management, and the like.

On the other hand, the operating system 150 of the electronic device 100 may be configured in such a manner that a plurality of operating systems work together for its operation. In other words, the electronic device 100 may be configured to execute a different operating system based on a kind of work being executed, an amount of usable resources in the implemented environment, and the like. Furthermore, the processing unit 180 may be implemented to include a plurality of controllers, and in this case, the plurality of operating systems may be operated as an operating system for operating individual controllers, respectively.

Assuming that the operating system 150 is configured to be divided into a first OS and a second OS, the first OS may be an operating system providing the operating environment of hardware executing a home appliance function of the electronic device 100, and the second OS may be a general-purpose operating system providing an environment for executing typical application programs such as executing a function supporting the operation of the user interface or the communication unit 110 of the electronic device 100. For instance, the first OS may be an operating system providing an environment with a small number of resources such as a real-time operating system (OS) being executed on the Micro Controller Unit (MCU), and the second OS may be a general-purpose operating system in which various application programs can be executed among embedded operating systems.

On the other hand, the operating system 150 may be changed through a firmware update process. The firmware update process may be carried out by a management command transmitted from the mobile station 500 to the DM client 171 through the DM server. The management command for the firmware update process may be a command for requesting the execution of an upgrade function.

The application program 160 refers to a program executed on the operating system 150.

The application program 160 may include a program for an intrinsic function of the home appliance module 130 mounted on the electronic device 100. Specifically, the processing unit 180 can control the home appliance module 130 connected to the interface unit 120 according to the application program 160.

For example, when the electronic device 100 is implemented such that hardware having a washing function is mounted thereon, control signals and status collection signals for managing the washing module such as a washing drum control unit, a washing water supply unit, a sensor unit, a detergent adjustment unit, a vibration adjustment unit or a horizontal adjustment unit are transmitted and received through the interface unit 120. In this case, control signals or the like for managing the washing module may be operated according to the application program 160 indicating washing methods or the like based on washing courses specifying washing, rinsing, dehydration method, sequence, time, collection and the like according to the information of washing objects such as clothes materials, textures and the like.

For another example, when the electronic device 100 is implemented such that hardware having a cooking function is mounted thereon, control signals and status collection signals for managing the cooking module such as a cooking unit, and a power/fuel control unit, a lighting unit, an air conditioning unit or a sensor unit are transmitted and received through the interface unit 120. In this case, control signals or the like for managing the cooking module may be operated according to the application program 160 indicating cooking methods or the like based on operation modes, cooking courses, or recipes.

For still another example, when the electronic device 100 is implemented such that hardware having a cleaning function is mounted thereon, control signals and status collection signals for managing the cleaning module such as a drive unit, a cleaning unit, an obstacle detection unit, a position recognition unit or a sensor unit are transmitted and received through the interface unit 120. In this case, control signals or the like for managing the cleaning module may be operated according to the application program 160 indicating cleaning methods.

For yet still another example, when the electronic device 100 is implemented such that hardware having a storage function is mounted thereon, control signals and status collection signals for managing the storage module such as a cooling unit, a temperature control unit, a sensor unit or a power controller are transmitted and received through the interface unit 120. In this case, control signals or the like for managing the storage module may be operated according to the application program 160 indicating storage methods or the like based on storage modes, fermentation modes or deposit modes.

On the other hand, the application program 160 may be changed through a software update process. The software update process may be carried out by a management command transmitted from the mobile station 500 to the DM client 171 through the DM server, and the management command for the software update process may be a command for requesting the execution of an upgrade function.

The management platform 170 indicates a management program executed on the operating system 150.

The management platform 170 may include a DM client 171. The DM client 171 transmits and/or receives management messages for the management of the electronic device 100 to and/or from the device management server (hereinafter, referred to as a “DM server”).

The management functions executed by the DM client 171 may include a management function of the home appliance module 130 mounted on the electronic device 100, for instance, monitoring, diagnosis, upgrade, remote control, and the like.

The monitoring function is a function of monitoring the status of the home appliance module 130. The DM client 171 is configured to collect events or log data generated from the home appliance module 130 through the monitoring function. For instance, when hardware having a cleaning function is mounted on the electronic device 100, the DM client 171 may collect events or log data for items including operation status, remaining time, initial setting time, washing course number, rinsing level, dehydration RPM, temperature or reserved washing time.

Furthermore, the diagnosis function is a function of diagnosing the status of the home appliance module 130. The DM client 171 may acquire error detection or diagnosis result generated from the home appliance module 130 through the diagnosis function.

The upgrade function is a function of updating the firmware, service or application program of the electronic device 100. The DM client 171 may update the operating system 150, the application program 160 or the management platform 170 stored in the memory 140 through the upgrade function. In addition, the DM client 171 may update software components including a module operated together with the communication unit 110 and module operated together with the interface unit 120 through the upgrade function.

The remote control function is a function of controlling the electronic device 100 from a remote location. The DM client 171 may control the operation of the home appliance module 130 through the remote control function. For instance, when hardware having a storage function is mounted on the electronic device 100, the DM client 171 may instruct the hardware having the storage function to perform the temperature control of a refrigerating chamber, a freezing chamber and the like, or perform a special freezing function and the like.

Furthermore, the management platform 170 may include a device management (DM) daemon 172. The DM daemon 172 may receive a notification message transmitted from the notification module of the management server 200 for the DM client 171. Furthermore, the DM daemon 172 may perform a function of processing the exceptional cases of the DM daemon 172.

Furthermore, the management platform 170 may include a service agent 173. The service agent 173 is used to allow the DM client 171 to control hardware within the electronic device 100 based on a management command or allow the processing unit 180 to execute the application program to control the hardware.

On the other hand, the memory 140 may include at least one type of storage medium such as Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, optical disk, flash memory type, hard disk type, multimedia card micro type, card type (for example, SD or xD memory etc.), and the like. Furthermore, the memory 140 may be a storage area form by means of a storage function provided by a network storage or cloud service connected through the communication unit 110.

The processing unit 180 controls the constituent elements of the electronic device 100 to perform the methods disclosed as the embodiments of the present disclosure. In other words, the processing unit 180 controls the communication unit 110, the interface unit 120, and the memory 140.

The processing unit 180 may be configured to implement software components stored in the memory 140. The processing unit 180 may control the home appliance module 130 connected to the interface unit 120 according to the application program 160.

The processing unit 180 may implement or update the application program 160 to perform a management command received from the management server 200 according to the embodiments disclosed herein.

Referring to FIG. 2, the management server 200 may include a communication unit 210, a memory 240, and a processing unit 280.

The communication unit 210 may perform communication with the electronic device 100 and the mobile station 500.

A program for operating the processing unit 280 may be stored in the memory 140, and input and output data may be temporarily stored therein. In particular, the memory 240 may store modules for transferring an execution request for a management command received from the mobile station 500 to the electronic device 100, and receiving an execution result of the management command from the electronic device 100. Specifically, the memory 240 may include at least one of an application programming interface (API) module 241, a connection module 242, a download server module 243, a device management server (hereinafter, referred to as a “DM server”) module 244, and a notification module 245.

First, the API module 241 is an interface module for providing device management services to the mobile station or application program located out of the management server 200. Specifically, the API module 241 may include at least one of an interface function for authentication to check whether the mobile station or application program accessing device management services are authorized, an interface function for performing a remote diagnosis of the electronic device 100, an interface function for monitoring the electronic device 100, an interface function for controlling an application program of the electronic device 100, and an interface function for controlling the home appliance module 130 of the electronic device 100. On the other hand, a function of providing the interface may be provided by a device having an independent form such as the API server.

Next, the connection module 242 may perform a message transfer function for transferring a management command request message transmitted from the mobile station located out of the management server 200 to the electronic device 100, and transferring a result of the execution of a management command based on the management command request message to the management server 200. On the other hand, the message transfer function may be carried out by a device having an independent form such as the connection server.

Next, the download server module 243 may perform a function of transmitting download data to the electronic device 100. The download server module 243 may be a module for transmitting download data according to the OMA download standard. On the other hand, the function of transmitting download data may be carried out by a device having an independent form such as the download server.

Next, the DM server module 244 may perform a function of requesting the execution of a management command through control message transmission and reception with the device management client (hereinafter, referred to as a “DM client”) performing a function for device management within the electronic device 100 and receiving a result of the execution of the management command. The DM server module 244 may transmit and receive messages for the management command according to the OMA DM standard. On the other hand, the function of transmitting and receiving control messages may be carried out by a device having an independent form such as the device management server.

Next, the notification module 245 may perform a notification function for transmitting and receiving a notification message for device management to the electronic device 100. The notification module 245 may exchange messages between the electronic device 100 and the DM server module in a push manner. Furthermore, the notification function may be carried out by a device having an independent form such as the notification server.

On the other hand, the management server 200 is illustrated in the form of a device in FIGS. 1 and 2, but may be also implemented to be divided into a plurality of servers performing different roles according to the implementation form. For example, the management server 200 may be divided into an API server, a connection server, a download server, a device management server and the like. However, the management server 200 being divided into a plurality of servers is only an example of the implementation form, and the configuration and method of the management server 200 is not construed to be limited to being implemented in the form of individually independent servers.

The processing unit 280 controls the constituent elements of the management server 200 to perform the methods disclosed as the embodiments of the present disclosure. In other words, the processing unit 280 controls the communication unit 210 and the memory 240. The processing unit 280 may be configured to implement modules stored in the memory 240.

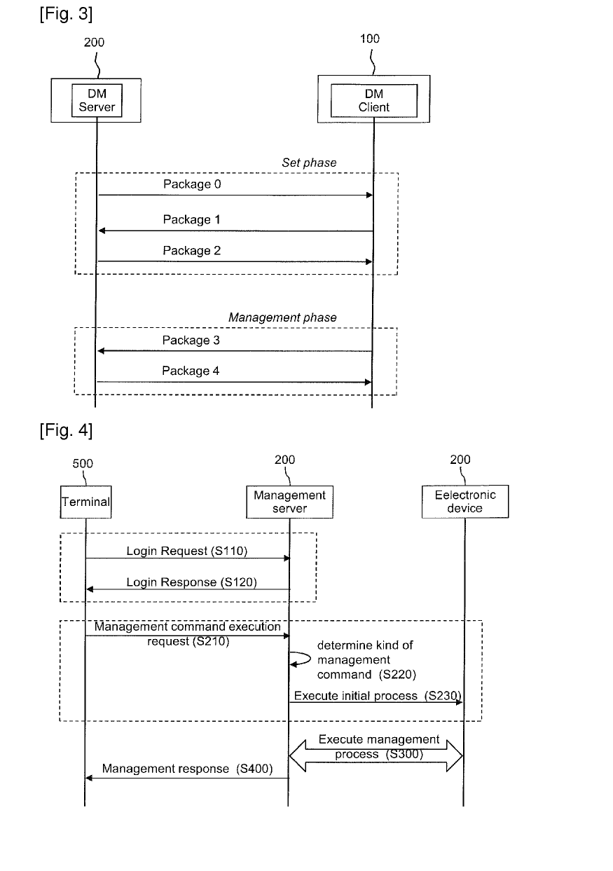

FIG. 3 illustrates processes in which an electronic device and a management server according to the OMA device management standard exchange messages for device management.

Referring to FIG. 3, a device management (DM) server within the management server 200 exchange control messages according to the device management standard of the Open Mobile Alliance (OMA) with the DM client 171 included in the electronic device 100 to perform management for the electronic device 100.

First, the management server 200 and the electronic device 100 transmit and receive package 0 (Package #0), package 1 (Package #1), and package 2 (Package #2) to perform the operation of a setup phase. The setup phase is a process of exchanging authentication and device information.

Specifically, the management server 200 transmits the package 0 corresponding to a trigger message for starting a management session to the electronic device 100. The electronic device 100 that has received the package 0 transmits the package 1 including the credentials of DM client 171 and device information to the management server 200. Next, the management server 200 that has received the package 1 examines the credentials of the DM client 171, and if the result of the examination is valid, transmits the package 2 including the credentials of the DM server and management commands to the electronic device 100.

Next, the management server 200 and the electronic device 100 transmit and receive package 3 (Package #3) and package 4 (Package #4) to perform the operation of a management phase. The management phase is a process of transmitting a result of the execution for the management command transmitted in the setup phase to the management server 200. Packages in the management phase may be continuously transmitted and received until the transmission of the execution result for the management command is completed.

Specifically, the electronic device 100 transmits the package 3 including a response to the management command to the management server 200. When an additional process for the management command is required, the management server 200 that has received the package 3 transmits the package 4 indicating that to the electronic device 100.

In exchanging control messages according to the foregoing OMA device management standard, the packages are data consisted of a markup language such as Synchronization Markup Language (SyncML), and the packages are included in the body of requests/responses according to the Hypertext Transfer Protocol (HTTP) to be transmitted and received. Furthermore, various transmission protocols may be used for a transmission means of the electronic device 100 and the management server 200 to exchange the packages. When the electronic device 100 has a wireless communication function, Short Message Service (SMS) or Wireless Application Protocol (WAP) Push or the like may be used to transmit the packages, but when the electronic device 100 has an Internet Protocol (IP) based network communication function, a connection through a typical Transport Control Protocol (TCP) socket, a connection through Secure Socket Layer (SSL) or the like may be used.

In order to perform a management command according to the foregoing OMA device management standard, the electronic device 100 and the management server 200 should consume a time for connection establishment each time to transmit the packages, respectively. However, an amount of time consumed to perform a management command in such a manner may be a problem for a management command in the real-time property.

Device management technologies according to an embodiment disclosed herein propose a scheme for changing a management command execution method for a device management command in the real-time property to reduce time consumed for that.

Furthermore, a device management method according to the OMA device management standard is carried out to allow a management server belong to a mobile communication operator or the like to collectively perform an update and report request command for the subscribers' mobile stations related to the mobile communication operator. According to the present disclosure, there is proposed a device management technology capable of allowing a user's mobile station to request the execution of a management command to an electronic device belong to the user. Furthermore, according to the present disclosure, there is proposed a device management technology capable of allowing a user's mobile station to access a management server belong to a manufacturer of the electronic device or a seller of the electronic device to relay the execution of the management command.

Hereinafter, referring to FIG. 4, a method of providing a device management service according to a first embodiment disclosed herein will be described. FIG. 4 illustrates a method in which a mobile station transfers a management command to an electronic device through a management server and receives an execution result.

The mobile station 500 transmits a management command request signal to the management server 200 according to the user's input. The management server 200 that has received the request signal judges a kind of management command contained in the request signal, and determines a method of instructing the management command according to a result of the determination. The management server 200 instructs the electronic device 100 to execute the management command according to the determined instruction method. Furthermore, when it is required that the execution result of the management command is transmitted, the management server 200 transmits that to the mobile station 500.

First, the management server 200 performs the process of examining whether the mobile station 500 is a proper device capable of requesting a management command to the electronic device 100 (S100).

Specifically, the mobile station 500 transmits a login request message to the management server 200 (S110).

The login request message may include information for authenticating the mobile station 500 or an application program for device management executed by the mobile station 500. The management server 200 may provide an interface in the form of Application Programming Interface (API) formed to allow an application program being carried out by an external device to execute a management command to the electronic device 100. The management server 200 authenticates an application program, device or user calling the interface to enable the allowed application program or device to call the interface. The login request message may be an authentication message used to inform that the electronic device 100 is enabled to use the interface.

The management server 200 examines credentials contained in the login request message, and when the mobile station 500 or an application program for device management being executed by the mobile station 500 is allowed to request a management command to the management server 200 as a result of the examination for the credentials contained in the login request message, the management server 200 transmits a login response message to the mobile station 500 (S120).

The login response message may include access information required for the mobile station 500 to request the execution of a management command later.

The access information may be access information of the management server 200 for receiving a request of the management command in the real-time property. For instance, the access information may be an IP address or TCP port of the management server 200.

Next, the mobile station 500 requests a management command to the management server 200, and the management server 200 judges a kind of the management command, and requests initialization for executing a management process to the electronic device 100 according to a result of the judgment for the kind of the management command (S200).

Specifically, the mobile station 500 accesses the management server 200 to request the execution of a management command (S210). Then, the management server 200 judges a kind of the requested management command (S220).

The kind of the management command may be distinguished by a method in which control messages for executing the management command are transmitted and received between the management server 200 and the electronic device 100. For instance, a first type of the management command instructs a method in which the transmission of an execution request and an execution result of the management command is carried out by transmitting and receiving control messages conforming to the OMA DM standard. The transmission and reception method conforming to the OMA DM standard repeats the establishment and release of a connection between the management server 200 and the electronic device 100 to transmit and receive a plurality of messages for the management command, and thus the first type may correspond to a management command indicating the non-real-time property in performing the management command.

Furthermore, a second type of the management command is a method in which the transmission of an execution request and an execution result of the management command is carried out by transmitting and receiving a plurality of data packets in a relay scheme through a connection oriented session, namely, through a connection continuously maintained between the management server 200 and the electronic device 100. The second type may correspond to a management command indicating the real-time property.

Whether or not the management command has the real-time property may be judges based on whether or not the management command should be carried out within a predetermined period of time after the management server 200 or the electronic device 100 receives the management command. For instance, management commands having the real-time property may include a monitoring command, a control command, or a diagnosis command. The monitoring command is a command for monitoring an operation status of the electronic device, and the control command is a command for changing the power, operating mode or job reservation status of the electronic device, and the diagnosis command is a command for examining whether there is an error in the operation of the electronic device. In addition, a management command for updating firmware or software of the electronic device may be regarded as the non-real-time property since the update operation is carried out within a prescribed time.

Furthermore, the management server 200 may judge a kind of the management command based on the form of API used to request the execution of the management command.

Furthermore, the management server 200 may judge a kind of the management command based on a characteristic of the connection to the mobile station 500 established for a request of the management command. For example, when the request of the management command is transmitted through a connection established according to the access information contained in the login response message, the management server 200 judges that the management command is the second type.

Next, the management server 200 performs an initial process for transferring the management command to the electronic device 100 according to a result of the judgment for the kind of the management command (S230). When the management command corresponds to the first type, the initial process (S230) may be a process of transmitting a trigger message to the electronic device 100. When the management command corresponds to the second type, the initial process (S230) may be a process of instructing the execution of the management command and establishing a session connection to be used to receive a result of the execution of the management command between the management server 200 and the electronic device 100.

Next, the management server 200 performs a management process according to the management command by requesting the execution of the management command to the electronic device 100, and transmitting and receiving control messages for receiving the execution result (S300). A method of transmitting and receiving control messages for device management in the management process (S300) may be configured in a different manner according to a kind of the management command.

Next, when required according to the kind of the management command, the management server 200 transmits a result of the execution of the management process to the mobile station 500 (S400).

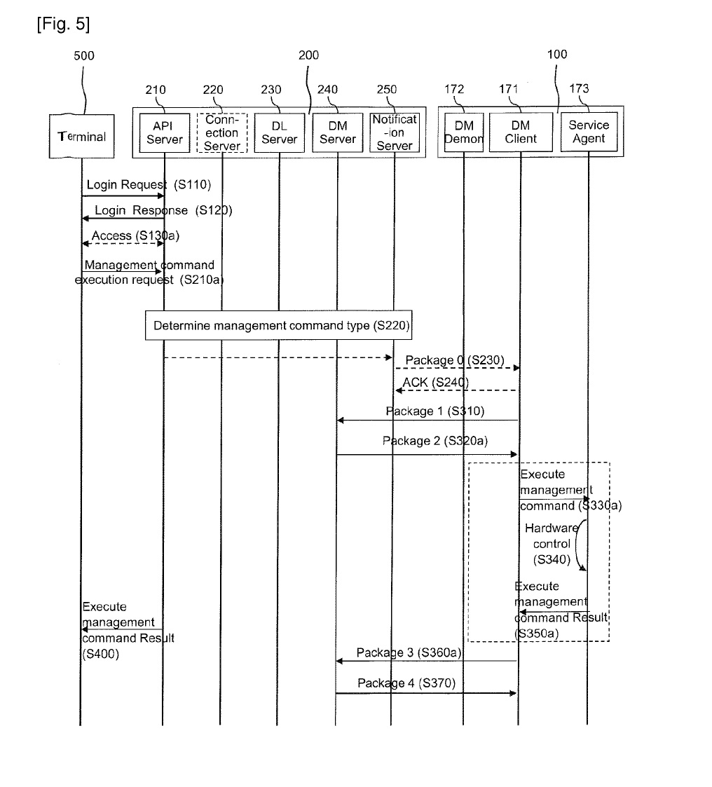

Hereinafter, referring to FIG. 5, a method of providing a device management service according to a second embodiment disclosed herein will be described. FIG. 5 illustrates the process of executing a device management command through an OMA DM message between an electronic device and a management server. The second embodiment, which will be described in the following, illustrates a specific implementation of the first embodiment, and the execution request and result transmission for a device management command are carried out through an OMA DM message between an electronic device and a management server.

First, the mobile station 500 transmits a login request message containing credentials to the management server 200 as described with reference to FIG. 4 (S110), and the management server 200 judges whether the mobile station 500 has an authority for requesting the execution of a management command based on the credentials, and transmits a result of the judgment to the mobile station 500 (S120).

Next, the mobile station 500 establishes a connection to the management server 200 if required (S130a). When a connection between the mobile station 500 and the management server 200 is established and maintained through the login request process (S110) or for other purposes, the connection establishment process (S130a) may be omitted.

Next, the mobile station 500 transmits a message for requesting a management command to the management server 200 through the connection established between the mobile station 500 and the management server 200 (S210a). The message for requesting a management command may be transmitted through API provided by the management server 200. Otherwise, the request for the management command may be contained in the login request message of the step S110 to be transmitted.

Next, the management server 200 judges a kind of message for requesting the management command transmitted from the mobile station 500 (S220). The process of judging a kind of message for requesting the management command is similar to the process described with reference to FIG. 4.

If it is not a case where a device that has received a request for the management command transmits the management command directly to the electronic device 100, then the management command may be transmitted to a server for instructing the electronic device 100.

Next, the management server 200 transmits a message for instructing the electronic device 100 to receive the management command (S230). When it is judged that the kind of message for requesting the management command has the non-real-time property, the message for instructing to receive the management command may be a trigger message for instructing the electronic device 100 to start a process of receiving the management command. Specifically, the message for instructing to receive the management command may be package 0 generated based on the OMA DM standard. Next, the management server 200 may transmit an acknowledge (ACK) message to the instruction message to the management server 200.

Next, the electronic device 100 that has received the instruction message transmits a message containing the credentials of the DM client 171 to the management server 200 (S310). The message containing the credentials of the DM client 171 may be package 1 generated based on the OMA DM standard.

Next, the management server 200 that has receive the credentials of the DM client 171 verifies the credentials of the DM client 171, and transmits a message containing the credentials of the DM server 240 and the management command to the electronic device 100 when the credentials of the DM client 171 are valid (S320a). The message containing the credentials of the DM server 240 and the management command may be package 2 generated based on the OMA DM standard.

Next, the electronic device 100 that has received the credentials of the DM server 240 verifies the credentials of the DM server 240, and executes the management command when the credentials of the DM server 240 are valid. The process of allowing the electronic device 100 to execute the management command may be configured, for example, such that the DM client 171 transmits a control signal based on the management command to the service agent 173 controlling hardware within the electronic device (S330a), and the service agent 173 controls the home appliance module 130 within the electronic device 100 based on the control signal (S340), and transmits the control result to the DM client 171 (S350a).

Next, the electronic device 100 transmits the execution result of the management command to the management server 200 (S360a). The execution result of the management command may be package 3 generated based on the OMA DM standard.

Next, when an additional process for the management command is required, the management server 200 may transmit a message for instructing to perform the additional process to the electronic device 100 (S370). The message for instructing to perform the additional process may be package 4 generated based on the OMA DM standard.

Next, when it is required to send the execution result of the management command to the mobile station 500 according to the kind of the management command, the management server 200 may perform a process of transmitting the execution result thereof to the mobile station 500 (S400).

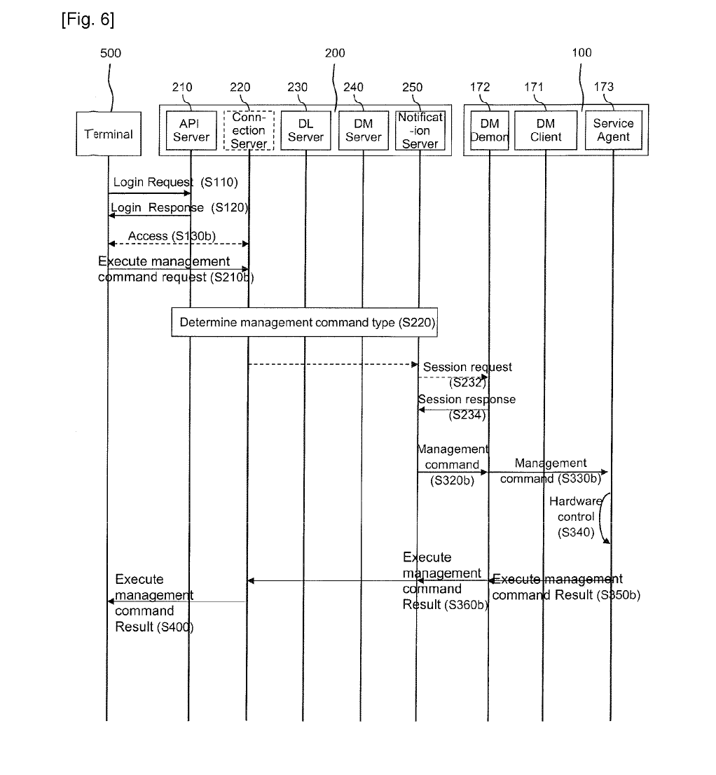

Hereinafter, referring to FIG. 6, a method of providing a device management service according to a third embodiment disclosed herein will be described. FIG. 6 illustrates the process of executing a device management command through a relay server between an electronic device and a management server. The third embodiment, which will be described in the following, illustrates a specific implementation of the first embodiment, and the execution request and result transmission for a device management command are carried out in a relay scheme through a connection oriented session, namely, through a relay server between an electronic device and a management server.

First, the mobile station 500 transmits a login request message containing credentials to the management server 200 as described with reference to FIG. 4 (S110), and the management server 200 judges whether the mobile station 500 has an authority for requesting the execution of a management command based on the credentials, and transmits a result of the judgment to the mobile station 500 (S120).

Next, the mobile station 500 establishes a connection to the management server 200 (S130b). For this purpose, the management server 200 may transmit association information required for the mobile station 500 to access, for example, information such as an IP address or TCP port of the management server 200, in advance, by containing the information in the acknowledge message (S120) to the login request. Furthermore, when a connection between the mobile station 500 and the management server 200 is established and maintained through the login request process (S110) or for other purposes, the connection establishment process (S130b) may be omitted.

Next, the mobile station 500 transmits a message for requesting a management command to the management server 200 through the connection established between the mobile station 500 and the management server 200 (S210b). The message for requesting a management command may be transmitted through API provided by the management server 200. Otherwise, the request for the management command may be contained in the login request message of the step S110 to be transmitted. However, when the management command for request is to perform a device management service in the real-time property, a message for requesting the management command may be transmitted using a connection established in the connection establishment process (S130b).

Next, the management server 200 judges a kind of the management command transmitted from the mobile station 500 (S220). The process of judging a kind of the management command is similar to the process described with reference to FIG. 4.

If it is not a case where a device that has received a request for the management command transmits the management command directly to the electronic device 100, then the management command may be transmitted to a server for instructing the electronic device 100.

Next, when the management command is judged as a kind having the real-time property, the management server 200 may establish a session to be used for the electronic device 100 to receive the management command, and transmit the execution result of the management command. For this purpose, the management server 200 may request a connection for establishing the session (S232), and the electronic device 100 may transmit a response to the session establishment in response to the connection request (S234).

On the other hand, a session for the management command may be implemented by a connection for which security is taken into account between the management server 200 and the electronic device 100. In other words, the management server 200 or the electronic device 100 may perform mutual authentication or unilateral authentication during the session establishment process. Furthermore, the connection for the session may be protected by encryption for confidentiality. For this purpose, SSL or the like may be used for the session, for example.

Next, the management server 200 transfers the management command to the electronic device 100 (S320b). The management command may be received by the DM daemon module 172 within the electronic device 100.

Next, the electronic device 100 executes the management command. The process of allowing the electronic device 100 to execute the management command may be configured, for example, such that the electronic device 100 transmits a control signal based on the management command to the service agent 173 controlling hardware within the electronic device (S330b), and the service agent 173 controls the home appliance module 130 within the electronic device 100 based on the control signal (S340), and transmits the control result to the DM client 171 (S350b).

On the other hand, when the home appliance module 130 should be repeatedly controlled to execute the management command, the foregoing execution processes (S330b to S350b) of the management command may be additionally carried out.

Next, the electronic device 100 transmits the execution result of the management command to the management server 200 through the established session (S360b). The established session is maintained without being released until the execution result of the management command is transmitted. Accordingly, a delay does not occur to establish a new connection or session in order to allow the electronic device 100 to transmit the execution result of the management command in the real-time property.

Next, when it is required to send the execution result of the management command to the mobile station 500 according to the kind of the management command, the management server 200 transmits the execution result to the mobile station 500 (S400).

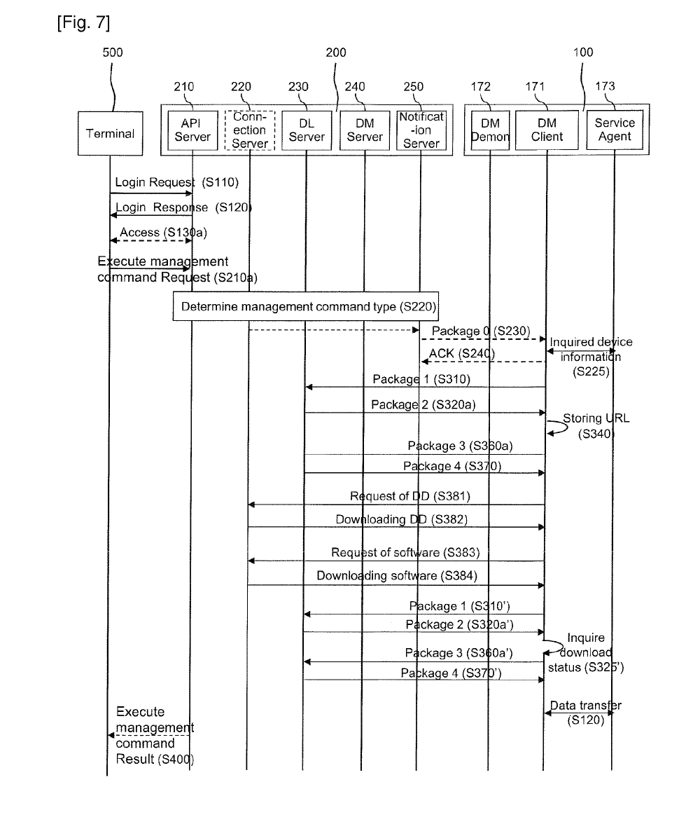

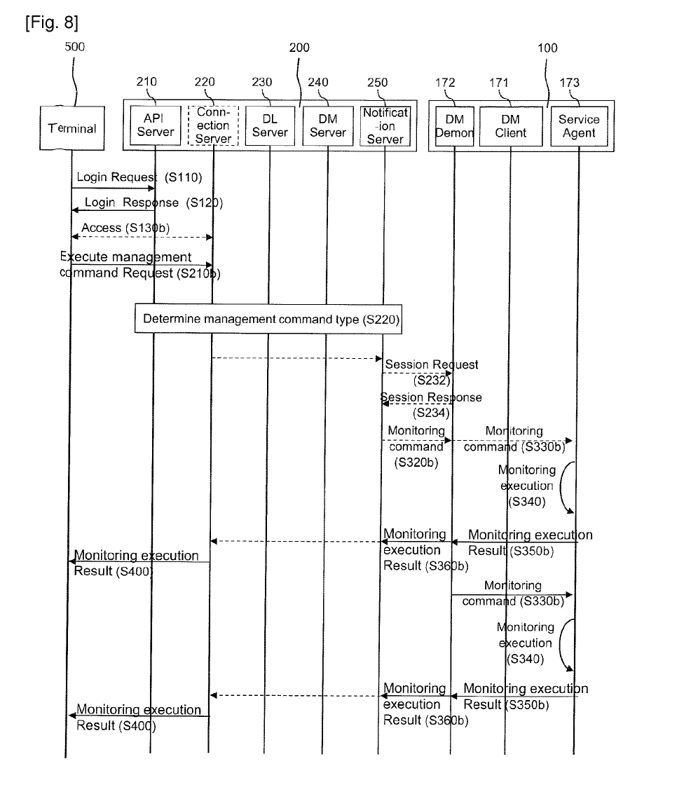

Hereinafter, referring to FIGS. 7 and 8, a method of performing firmware update and monitoring will be disclosed as an example of a management command to the electronic device in a device management service system.

FIG. 7 is a flow chart for explaining the process of updating an application program of the electronic device according to a request of the mobile station as an example of the device management method disclosed herein.

First, the processes of allowing the management server 200 to perform authentication, establish a connection, receive a management command request, and judge a kind of the management command are similar to the processes (S110 to S220) described with reference to FIG. 5. Specifically, the management command requested by the mobile station 500 to the management server 200 is a command for requesting an update of the application program, which is requested through API provided by the management server 200. Furthermore, the update of the application program is a management command showing the non-real-time property, and the management server 200 determines to perform an update command of the application program using a transmission and reception method conforming to the OMA DM standard in the process of judging a kind of the management command (S220).

Next, subsequent to receiving the update request, the management server 200 transmits package 0 corresponding to a trigger message to the electronic device 100 (S230), and receives package 1 containing device credentials and device information from the electronic device 100 (S310). Then, the management server 200 transmits package 2 containing server credentials, URL information of the application program and a download start command to the electronic device 100 (S320a). The electronic device 100 that has received the package 2 stores the URL information of the application program (S325), and transmits package 3 to inform that the update command has been stored through the package 2 (S360a). The management server 200 transmits package 4 in response to the package 3 (S370).

Next, the electronic device 100 may perform a download process based on the stored URL information according to the received application program update command. The electronic device 100 requests a download descriptor (hereinafter, referred to as “DD”) for the application program to be downloaded using a URL of the DD extracted from the stored URL information (S381), and receives DD for the application program to be downloaded from the management server 200 (S382). Then, the electronic device 100 requests the application program to be downloaded using a URL of the DD extracted from the stored URL information (S383), and receives the application program to be downloaded from the management server 200 (S384).

Then, the electronic device 100 transmits package 1 to the management server 200 to transfer the download result (S310′), and the management server 200 transfers package 2 containing a management command for checking a download status to the electronic device 100 (S320a′). Then, the electronic device 100 inquires a command processing status for the software download (S325′), and transmits package 3 containing the inquired command processing result to the management server 200. Then, the electronic device 100 transfers it to the service agent 173 such that the received software and DD are updated for the home appliance module 130 of the electronic device 100. The management server 200 can transfer the execution result of the management command to the mobile station 500.

FIG. 8 is a flow chart for explaining the process of performing the monitoring of the electronic device according to a request of the mobile station as an example of the device management method disclosed herein.

First, the processes of allowing the management server 200 to perform authentication, establish a connection, receive a management command request, and judge a kind of the management command are similar to the processes (S110 to S220) described with reference to FIG. 6. Specifically, the management command requested by the mobile station 500 to the management server 200 is a command for requesting the execution of monitoring for the electronic device, which is requested through API provided by the management server 200. Furthermore, the execution of monitoring is a management command showing the real-time property, and the management server 200 determines to perform the monitoring command using a transmission and reception method through the relay server in the process of judging a kind of the management command (S220). On the other hand, when the connection server 220 operated in an independent manner is requested to execute the monitoring command from the mobile station 500, the connection server 220 can transfer the monitoring command to a server performing a relay process to the electronic device 100, for example, the notification server 250.

Then, when a session for relaying the monitoring command received from the mobile station 500 to the electronic device 100 is not established, the management server 200 requests a connection for establishing the session (S232), and the electronic device 100 transfers a response to the session establishment in response to the connection request (S234), thereby establishing a session with the electronic device 100.

Then, the management server 200 transfers the monitoring command to the electronic device 100 (S320b), and executes the management command. Specifically, the electronic device 100 transfers the monitoring command to the service agent 173 controlling the home appliance module 130 which is an object of the monitoring command (S330b), and the service agent 173 performs monitoring to the home appliance module 130 based on the monitoring command (S340), and the electronic device 100 receives a result of the execution of monitoring from the service agent 173 (S350b).

Then, the electronic device 100 transmits the received execution result of monitoring to the management server 200 (S360b). The management server 200 that has received the execution result of monitoring from the electronic device 100 can transmit the execution result of monitoring to the mobile station 500 (S400), and furthermore, when there is an additional operation for the monitoring command, the processes of executing a monitoring command through the service agent 173 (S330b to S350b) can be carried out again.

In the following embodiments, the constituent elements and features of the present disclosure are combined with one another in a predetermined form. Each constituent element or feature thereof should be considered to be selective as unless otherwise particularly specified. Each constituent element or feature thereof may be implemented in a form that is not combined with any other constituent elements or features. Furthermore, an embodiment of the present disclosure may be also configured by combining some of the constituent elements and/or features. The sequence of the operations described in the embodiments of the present disclosure may be changed. Some of the configurations or features of any embodiment may be included in any other embodiments, or may be replaced with the configurations and features corresponding to the any other embodiments. In addition, it will be apparent that an embodiment may be configured by a combination of claims cited by each other and a new claim may be included by the amendment after filing the application.

The present invention may be embodied in other specific forms without departing from the concept and essential characteristics thereof. The detailed description is, therefore, not to be construed as illustrative in all respects but considered as restrictive. The scope of the invention should be determined by reasonable interpretation of the appended claims and all changes that come within the equivalent scope of the invention are included in the scope of the invention. In addition, it will be apparent that an embodiment may be configured by a combination of claims cited by each other and a new claim may be included by the amendment after filing the application.

1. An operation method of a device management server for relaying a device management command, the method comprising:
receiving a management command from a first device;
determining an execution method of the management command as a relay scheme or message exchange scheme according to a kind of the management command; and
transmitting a management command for a second device according to the execution method.

2. The method of claim 1, wherein said determining an execution method of the management command comprises:
judging whether the management command requires real-time execution; and
determining the execution method according to the judgement result.

3. The method of claim 2, wherein the execution method is determined as the relay scheme when it is judged that the management command requires real-time execution in the step of determining the execution method.

4. The method of claim 3, wherein said transmitting the management command according to the relay scheme comprises:
establishing a connection oriented session with the second device;
transmitting the management command through the session; and
receiving an execution result of the management command from the second device through the session.

5. The method of claim 4, wherein the connection oriented session is maintained without being released until receiving an execution result of the management command from the second device.

6. The method of claim 5, further comprising:
transmitting an execution result of the management command received from the second device to the first device.

7. The method of claim 2, wherein said judging whether the management command requires real-time execution is judging whether the management command should be executed within a predetermined period of time after receiving the management command.

8. The method of claim 7, wherein a monitoring command for monitoring an operation status of the second device is judged to require real-time execution in the step of judging whether to require the real-time execution.

9. The method of claim 7, wherein a control command for changing the power, operating mode or job reservation status of the second device is judged to require real-time execution in the step of judging whether to require the real-time execution.

10. The method of claim 7, wherein a diagnosis command for examining whether there is an error in the operation of the second device is judged to require real-time execution in the step of judging whether to require the real-time execution.

11. The method of claim 2, wherein said transmitting the management command according to the relay scheme is transmitting the management command according to a scheme of transferring the management command conforming to the device management standard of the Open Mobile Alliance (OMA).

12. A device management server for relaying a device management command, the server comprising:
a communication unit configured to perform communication with a first device and a second device; and
a controller configured to control the communication unit,
wherein the controller controls to receive a management command from the first device, determine an execution method of the management command as a relay scheme or message exchange scheme according to a kind of the management command, and transmit a management command for a second device according to the execution method.

13. The server of claim 12, wherein the controller judges whether the management command requires real-time execution, and determines the execution method of the management command according to the judgement result.

14. The server of claim 13, wherein the controller determines the execution method as the relay scheme when it is judged that the management command requires real-time execution.

15. The server of claim 14, wherein the relay scheme transmits the management command and receives an execution result of the management command through a connection oriented session established with the second device, and
the connection oriented session is maintained without being released until receiving an execution result of the management command from the second device.

16. The server of claim 15, wherein a monitoring command for monitoring an operation status of the second device, a control command for changing the power, operating mode or job reservation status of the second device, and a diagnosis command for examining whether there is an error in the operation of the second device are judged to require real-time execution when judging whether the management command requires real-time execution.

17. An electronic device, comprising:
a home appliance module;
a memory configured to store a monitoring program for monitoring the home appliance module;
a communication unit configured to perform communication with a device management server; and
a controller configured to manage the monitoring program using a message exchange scheme or relay scheme with the device management server,
wherein the controller receives an update command for the monitoring program from the device management server using the message exchange scheme, and updates the monitoring program according to the update command, and transmits the updated result of the monitoring program to the device management server using the message exchange scheme, and
receives a monitoring command from the device management server using the relay scheme, and executes the monitoring program based on the monitoring command to acquire the status information of the home appliance module, and transmits the status information to the device management server using the relay scheme.
